(19) United States
(12) Patent Application Publication
(10) Pub. No.: US 2011/0167177 A1
(43) Pub. Date: Jul. 7, 2011

(54) MAIN BODY DEVICE, EXTERNAL DEVICE, AND COMMUNICATION SYSTEM

(75) Inventors: Tomoaki KOUYAMA, Nagoya-shi (JP); Makoto Oya, Nagoya-shi (JP)

(73) Assignee: Buffalo Inc., Nagoya-shi (JP)

(21) Appl. No.: 12/981,919

(22) Filed: Dec. 30, 2010

(30) Foreign Application Priority Data
Jan. 4, 2010 (JP) P2010-000246

(51) Int. Cl. G06F 3/00

(52) U.S. Cl. 710/11

(57) ABSTRACT

A storage device main body 100 comprising: a main body side connector 130 to which a cartridge type HDD 200 is connected and having a structure compliant with a SATA standard; a SATA controller 140 for communicating with the cartridge type HDD 200 in compliance with the SATA standard by using a main body side SATA signal connector 120 provided in the main body side connector 130; and a USB controller 180 for communicating with the cartridge type HDD 200 in compliance with a USB standard by using one of the 3.3V pins of a main body side SATA power connector 110 provided in the main body side connector 130.

### CROSS REFERENCE TO RELATED APPLICATION

This application is based upon and claims the benefit of priority from, the prior Japanese Patent Application No. 2010-000246 filed on Jan. 4, 2010; the entire contents of which are incorporated herein by reference.

### BACKGROUND OF THE INVENTION

1. Field of the Invention

The present invention relates to a main body device, an external device, and a communication system which support various interface standards.

2. Description of the Related Art

Heretofore, a communication system has been widely used in which a main body device and an external device, such as a hard disk drive (HDD), mounted on the main body device communicate with each other by using any one of interface standards including the Serial Advanced Technology Attachment (SATA) standard and the Universal Serial Bus (USB) standard.

Note that, in the following, the USB standard includes various USB standards such as USB 1.1/2.0/3.0, and the SATA standard includes various SATA standards such as SATA/eSATA.

An external device supporting the interface standards, the SATA standard and the USB standard, has been recently proposed (see Patent Document 1: Japanese Patent Application Publication No. 2008-165489). The external device described in Patent Document 1 includes a SATA connector (specifically, eSATA connector) having a structure compliant with the SATA standard, and a USB connector having a structure compliant with the USB standard. Further, a main body device described in Patent Document 1 includes a SATA connector and a USB connector similar to the external device.

### SUMMARY OF THE INVENTION

The external device and the main body device described in Patent Document 1 have the following problem. Specifically due to their configuration including the two connectors, the SATA connector and the USB connector, the external device and the main body device incur cost increase as compared to those having a configuration including only one connector.

Thus, the present invention has an object to provide a main body device, an external device, and a communication system which can be constructed without cost increase. To this end, the present invention allows the main body device, the external device, and the communication system to support communications compliant with a second interface standard while maintaining compatibility with a first interface standard, by using their respective connectors each having a structure compliant with the first interface standard.

The present invention has the following features to solve the problems described above. First of all, a first feature of the present invention is summarized as a main body device (for example, storage device main body 100) comprising: a main body side connector (for example, main body side connector 130) to which an external device (for example, cartridge type HDD 200) is connected and having a structure compliant with a first interface standard (for example, SATA standard); a first main body side communication unit (for example, SATA controller 140) for communicating with the external device in compliance with the first interface standard by using a main body side signal pin (for example, main body side SATA signal connector 120) provided in the main body side connector; and a second main body side communication unit (for example, USB controller 180) for communicating with the external device in compliance with a second interface standard (for example, USB standard) by using a selected number (for example, pins 110a to 110c) of main body side power supply pins (for example, main body side SATA power connector 110) provided in the main body side connector.

The main body device described above can perform communications compliant with the first and second interface standards, by using the one main body side connector having a structure compliant with the first interface standard. Thus, the main body device can support plural interface standards while suppressing cost increase.

Here, among the plural main body side power supply pins provided in the main body side connector, some selected pins may be used for power supply to the external device as usual. Further, the main body side signal pin is used for communications compliant with the first interface standard as usual. Hence, even when the selected number of the main body side power supply pins are used for communications compliant with the second interface standard, power supply to the external device is guaranteed by the rest of the main body side power supply pins, and communications compliant with the first interface standard are guaranteed through the main body side signal pin.

Note that, although defined in the first interface standard, the selected number of the main body side power supply pins are usually rarely used. The present invention allows maintaining compatibility with the first interface standard as well as supporting the second interface standard, by using such rarely used power supply pins effectively.

A second feature of the present invention is summarized as the main body device according to the first feature described above, wherein, in the first interface standard, the selected number of main body side power supply pins are used for supplying a power supply voltage lower than a withstand voltage (for example, 3.3V) according to the second interface standard.

A third feature of the present invention is summarized as the main body device according to the first feature described above, further comprising: a check unit (e.g. CPU 150) for checking whether or not the external device includes a specific built-in device (for example, USB device 260) to perform communications compliant with the second interface standard, according to a voltage applied from the external device to any selected one (for example, pin 110c) of the main body side power supply pins, wherein the second main body side communication unit communicates with the external device in compliance with the second interface standard if the check unit confirms that the external device includes the specific built-in device.

A fourth feature of the present invention is summarized as the main body device according to the first feature as described above, further comprising: a main body side power supply unit (for example, power supply unit 190) for supplying a power supply voltage to the external device through the rest of the main body side power supply pins other than the selected number of the main body side power supply pins.

A fifth feature of the present invention is summarized as the main body device according to the first feature as described above, wherein the first interface standard is a SATA standard or a SAS standard.

A sixth feature of the present invention is summarized as the main body device according to the first feature as described above, wherein the second interface standard is a USB standard or a LVDS standard.

A seventh of the present invention is summarized as the main body device according to the first feature as described above, wherein the external device (for example, cartridge type HDD 200) comprising: an external side connector (for example, HDD side connector 230) connected to the main body device (for example, storage device main body 100) and having a e structure compliant with a first interface standard (for example, SATA standard); a first external side communication unit (for example, SATA controller 240) for communicating with the main body device in compliance with the first interface standard by using an external side signal pin (for example, HDD side SATA signal connector 220) provided in the external side connector; and a second external side communication unit (for example, USB controller 280) for communicating with the main body device in compliance with a second interface standard (for example, USB standard) by using those external side power supply pins (for example, pins 210a to 210c) which are among plural external side power supply pins (for example, HDD side SATA power connector 210) provided in the external side connector.

The external device described above can perform communications compliant with the first and second interface standards, by using the external side connector having a structure compliant with the first interface standard. Thus, the external device can support plural interface standards while suppressing cost increase.

Here, among the plural external side power supply pins provided in the external side connector, the rest of the external side power supply pins other than the selected number of the external side power supply pins may be used for receiving power supply from the main body device as usual. Further, the external side signal pin is used for communications compliant with the first interface standard as usual. Hence, even when the selected external side power supply pins are used for communications compliant with the second interface standard, the reception of power supply from the main body device is guaranteed through the rest of the external side power supply pins, and communications compliant with the first interface standard are guaranteed through the external side signal pin.

Note that, although defined in the first interface standard, the selected number of the external side power supply pins are usually rarely used. The present invention allows maintaining compatibility with the first interface standard as well as supporting the second interface standard, by using such rarely used power supply pins effectively.

An eighth feature of the present invention is summarized as the external device according to the seventh feature as described above, wherein, in the first interface standard, the selected number of the external side power supply pins are used for receiving a power supply voltage lower than a withstand voltage (for example, 3.3V) according to the second interface standard.

A ninth feature of the present invention is summarized as the external device according to the seventh feature as described above, further comprising a specific device (for example, USB device 260) to perform communications compliant with the second interface standard.

A tenth feature of the present invention is summarized as the external device according to the seventh feature as described above, further comprising an external side power supply unit (for example, power supply unit 290) for receiving a power supply voltage from the main body device by using the rest of the plurality of external side power supply pins other than the selected number of the external side power supply pins.

An eleventh feature of the present invention is summarized as the external device according to the seventh feature as described above, wherein the first interface standard is a SATA standard or a SAS standard.

A twelfth feature of the present invention is summarized as the external device according to the seventh feature as described above, wherein the second interface standard is a USB standard or a LVDS standard.

A thirteenth feature of the present invention is summarized as a communication system comprising: a main body device; and an external device mounted on the main body device, wherein the main body device comprises: a main body side connector to which an external device is connected and having a structure compliant with a first interface standard; a first main body side communication unit for communicating with the external device in compliance with the first interface standard by using a main body side signal pin provided in the main body side connector; and a second main body side communication unit for communicating with the external device in compliance with a second interface standard by using a selected number of main body side power supply pins provided in the main body side connector, and the external device comprises: an external side connector connected to the main body device and having a structure compliant with the first interface standard; a first external side communication unit for communicating with the main body device in compliance with the first interface standard by using an external side signal pin provided in the external side connector; and a second external side communication unit for communicating with the main body device in compliance with the second interface standard by using a selected number of external side power supply pins provided in the external side connector.

### BRIEF DESCRIPTION OF THE DRAWINGS

FIG. 1 is an entire schematic configuration diagram including a NAS according to an embodiment of the present invention.

FIG. 2 is a plan view showing a main storage device and a cartridge type HDD as the cartridge type HDD is inserted in the main storage device according to the embodiment of the present invention.

FIG. 3 is a block diagram showing a configuration of the NAS according to the embodiment of the present invention.

FIG. 4 is a diagram showing a detailed configuration of a SATA power connector on the main body, and another SATA power connector on the HDD according to the embodiment of the present invention.

FIG. 5 is a flowchart showing the operation of a CPU according to the embodiment of the present invention.

FIG. 6 is a diagram illustrating Operational Example 1 according to the embodiment of the present invention.

FIG. 7 is a diagram illustrating Operational Example 2 according to the embodiment of the present invention.

FIG. 8 is a diagram showing a modification of the embodiment of the present invention.

### DESCRIPTION OF EMBODIMENTS

Next, an embodiment of the present invention is described with reference to the drawings. In the following description of the embodiments, the same or similar components are labeled with the same or similar reference numerals.

It should be noted that the drawings are schematic, and ratios between dimensions are different from actual ones. Accordingly, specific dimensions should be determined in consideration of the following description. Of course, the drawings include some portions between which dimensional relationship and ratios are different from each other.

In the following, an embodiment in the case where a communication system of the present invention is applied to a storage device supporting network, network attached storage (NAS) is described.

A NAS according to the present embodiment has a removable storage medium as an external device. A case where a hard disk drive (HDD) using a magnetic disc is utilized as the storage medium is illustrated, but a solid state drive (SSD) using a nonvolatile memory, or an optical drive may be used instead of the HDD.

In the following, (1) Entire Schematic Configuration, (2) Detailed Configuration, (3) Operation of CPU, (4) Operation Specific Example, (5) Effects and Advantages of Embodiment, (6) Modification of Embodiment, and (7) Other Embodiments are described in this order named.

### (1) Entire Schematic Configuration

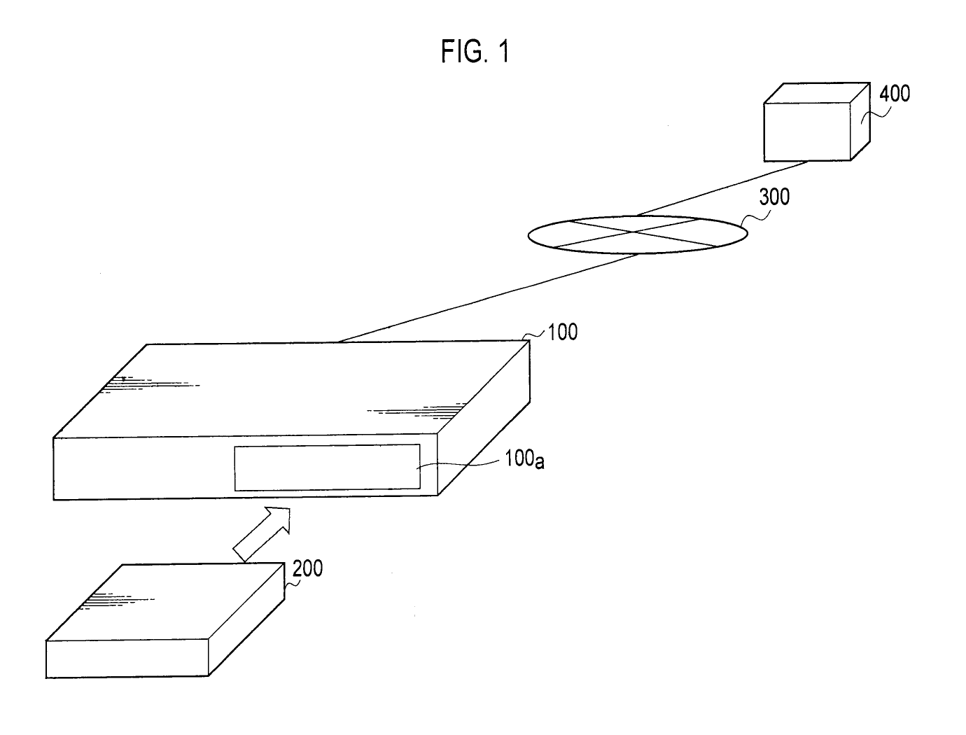

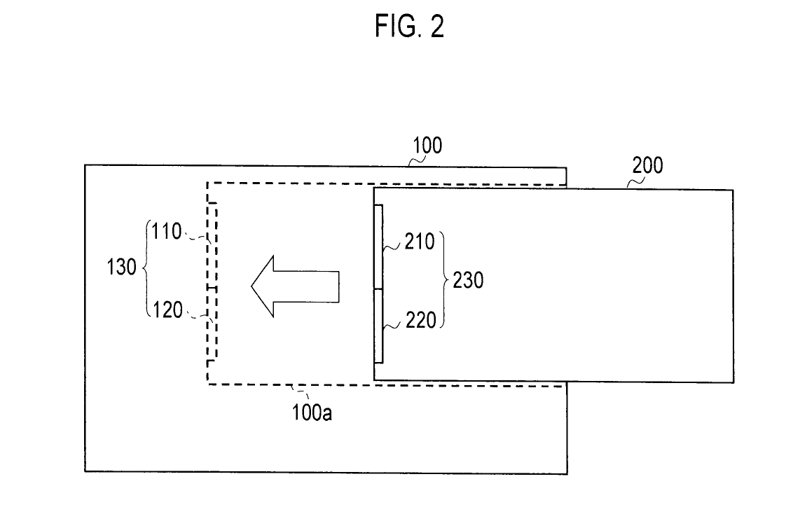

First, by referring to FIGS. 1 and 2, the entire schematic configuration of the NAS according to the present embodiment is described.

FIG. 1 is an entire schematic configuration diagram including the NAS according to the present embodiment. In the present embodiment, the NAS comprises a storage device main body 100 (main body device) and a cartridge type HDD 200 (external device).

The storage device main body 100 is connected to a network 300 such as a home network. The storage device main body 100 transmits a command and data to and receives the same from, a client terminal 400 such as a PC or a television receiver via the network 300. The storage device main body 100 performs data writing to and data reading from, the cartridge type HDD 200 according to the command.

The storage device main body 100 has a HDD slot 100a into which the cartridge type HDD 200 is inserted. The cartridge type HDD 200 is a HDD housed in a cartridge, and can be removably mounted in the storage device main body 100.

For simplification of description for FIG. 1, only one HDD slot 100a is provided in the storage device main body 100. However, more than one HDD slot 100a may be provided in the storage device main body 100.

Because the cartridge type HDD 200 can be removably mounted in the storage device main body 100, if the cartridge type HDD 200 does not have sufficient memory capacity, the memory can be augmented by adding another cartridge type HDD 200. Also, different cartridge type HDDs 200 can be used for different types of data to be stored.

FIG. 2 is a plan view showing the storage device main body 100 and the cartridge type HDD 200 as the cartridge type HDD 200 is inserted in the storage device main body 100.

As shown in FIG. 2, the HDD slot 100a of the storage device main body 100 is provided with a main body side connector 130. The cartridge type HDD 200 is provided with a HDD side connector 230. In the present embodiment, the HDD side connector 230 corresponds to the external side connector, and the main body side connector 130 corresponds to the main body device connector.

Communications via the main body side connector 130 and the HDD side connector 230 are made possible by inserting the cartridge type HDD 200 in the storage device main body 100 and electrically connecting the main body side connector 130 and the HDD side connector 230 with each other.

In the present embodiment, the main body side connector 130 and the HDD side connector 230 each have a structure compliant with the SATA standard which is one of the interface standards.

In the SATA standard, a power pin group and a signal pin group are separately provided. In other words, the main body side connector 130 has a main body side SATA power connector 110 which is a power pin group, and a main body side SATA signal connector 120 which is a signal pin group.

Similarly, the HDD side connector 230 has a HDD side SATA power connector 210 which is a power pin group, and a HDD side SATA signal connector 220 which is a signal pin group.

The main body side SATA power connector 110 and the HDD side SATA power connector 210 are connected to each other, and the main body side SATA signal connector 120 and the HDD side SATA signal connector 220 are connected to each other.

### (2) Detailed Configuration

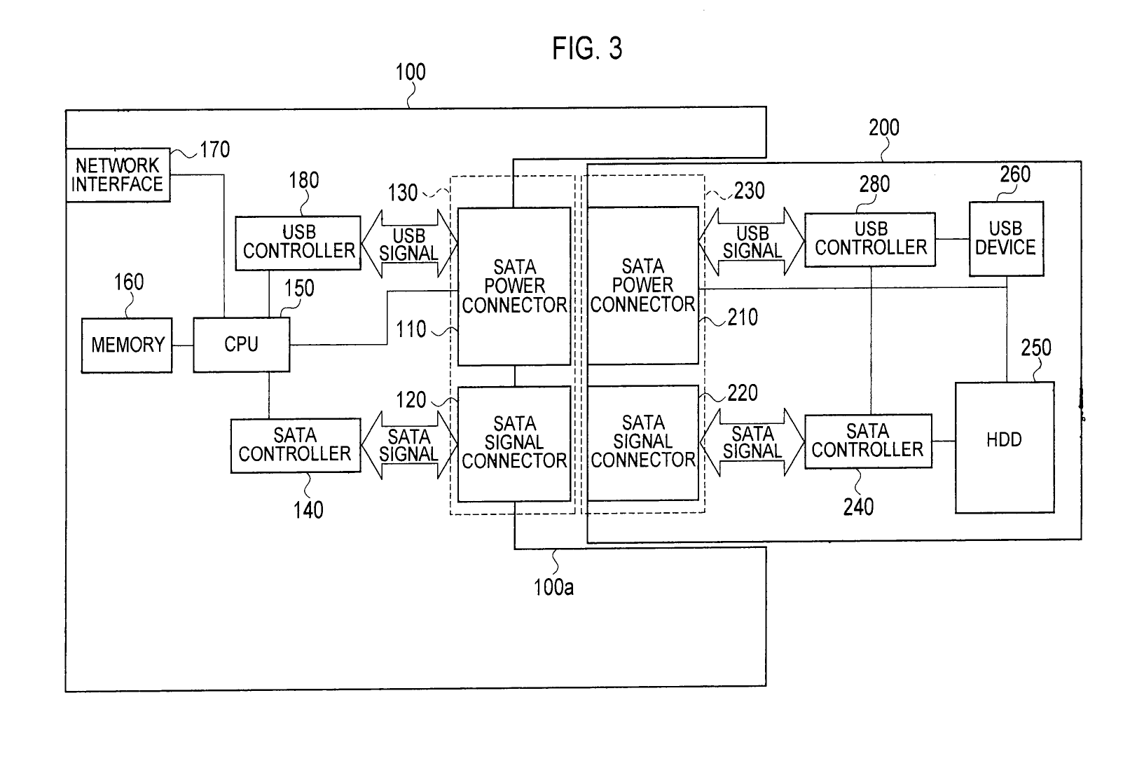

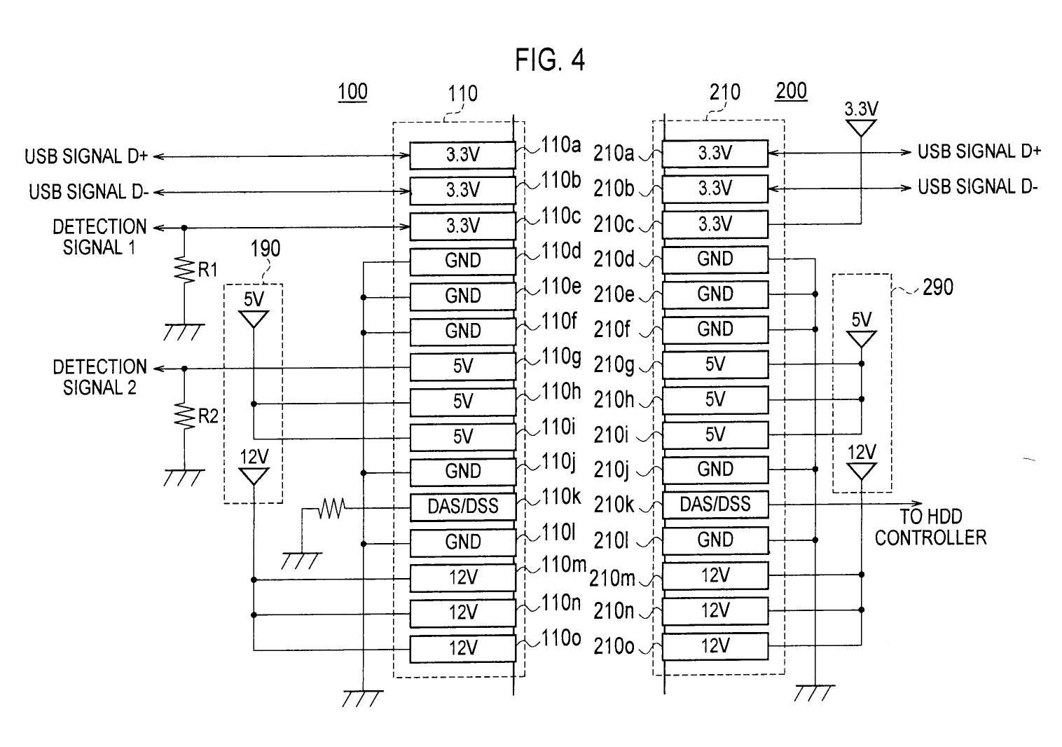

Next, by referring to FIGS. 3 and 4, a detailed configuration of the NAS according to the present embodiment is described. However, description of configurations not related to the present invention is omitted.

FIG. 3 is a block diagram showing a configuration of the NAS according to the present embodiment.

As shown in FIG. 3, the cartridge type HDD 200 has a SATA controller 240, a HDD 250, a USB controller 280, and a USB device 260 in addition to the HDD side SATA power connector 210 and the HDD side SATA signal connector 220.

The SATA controller 240, the HDD 250, the USB device 260, and the USB controller 280 are driven with a power supply voltage supplied from the main body side SATA power connector 110 to the HDD side SATA power connector 210.

According to the SATA standard, three types of power supply voltages, i.e. 12V, 5V, and 3.3V, can be supplied, but in the present embodiment, the main body side SATA power connector 110 supplies only 12V and 5V. A power supply voltage of 3.3V can be derived from a power supply voltage of 12V or 5V.

The SATA controller 240 controls data writing to the HDD 250, data reading from the HDD 250 and the like. The SATA controller 240 also transmits and receives a SATA signal to and from the storage device main body 100 via the HDD side SATA signal connector 220. In the present embodiment, the SATA controller 240 corresponds to a first external side communication unit which communicates with the storage device main body 100 in compliance with the SATA standard as a first interface standard.

The HDD 250 comprises a magnetic disc and a motor which drives the magnetic disc.

The USB device 260 supports communications compliant with the USB standard. Examples of the USB device 260 include a nonvolatile semiconductor memory, a tuner, and the like.

The USB controller 280 controls the USB device 260, and transmits a USB signal to and receives the same from, the storage device main body 100 via the HDD side SATA power connector 210. In the present embodiment, the USB controller 280 corresponds to a second external side communication unit which communicates with the main body device in compliance with the USB standard as a second interface standard. Note that, the USB signal appears as differential signals (D+, D−) having inverted logics (see FIG. 4).

On the other hand, the storage device main body 100 includes a SATA controller 140, a CPU 150, a memory 160, a network interface 170, and an USB controller 180 in addition to the main body side SATA power connector 110 and the main body side SATA signal connector 120.

The SATA controller 140 transmits and receives a SATA signal via the main body side SATA signal connector 120. In the present embodiment, the SATA controller 140 corresponds to a first main body side communication unit which communicates with the cartridge type HDD 200 in compliance with the SATA standard as the first interface standard.

The memory 160 is, for example, a nonvolatile semiconductor memory, and the CPU 150 controls the entire storage device main body 100 by executing programs stored in the memory 160.

The CPU 150 functions to detect the connection of the HDD side connector 230 to the main body side connector 130, and to check whether the cartridge type HDD 200 has the USB device 260 built in. In other words, the CPU 150 corresponds to a check unit in the present embodiment. The CPU 150 may check whether the cartridge type HDD 200 is operating normally when detecting the connection of the HDD side connector 230 to the main body side connector 130. The operation of the CPU 150 is described in detail later.

The network interface 170 is connected to the network 300, and inputs and outputs a command or data.

The USB controller 180 transmits and receives a USB signal via the main body side SATA power connector 110. In the present embodiment, the USB controller 180 corresponds to a second main body side communication unit which communicates with the cartridge type HDD 200 in compliance with the USB standard as the second interface standard.

FIG. 4 is a diagram showing the detailed configurations of the main body side SATA power connector 110 and the HDD side SATA power connector 210.

As shown in FIG. 4, the main body side SATA power connector 110 has pins 110a to 110o, and the HDD side SATA power connector 210 has pins 210a to 210o. The pin arrangements of each of the main body side SATA power connector 110 and the HDD side SATA power connector 210 comply with the SATA standard.

In compliance with the SATA standard, most of the pins 110a to 110o and 210a to 210o are power supply pins used for current supply and ground pins used for grounding. In particular, the pins 110a to 110c and 210a to 210c are power supply pins for a voltage of 3.3V. The pins 110d to 110f, 110j, 110l, 210d to 210f, 210j, and 210l are ground pins. The pins 110k and 210k are Device Activity Signal/Disable Staggered Spinup (DAS/DSS) pins. The pins 110m to 110o and 210m to 210o are power supply pins for a voltage of 12V.

The 3.3V power supply pins 110a to 110c and 210a to 210c are usually rarely used although defined in the SATA standard.

The 3.3V pins 110a and 110b are connected to the USB controller 180. The USB controller 180 performs communications compliant with the USB standard by using the 3.3V pins 110a and 110b. The 3.3V pin 110a is used for transmitting the USB signal D+, whereas the 3.3V pin 110b is used for transmitting the USB signal D−.

The 3.3V pins 210a and 210b are connected to the USB controller 280. The USB controller 280 performs communications compliant with the USB standard by using the 3.3V pins 210a and 210b. The 3.3V pin 210a is used for transmitting the USB signal D+, whereas the 3.3V pin 210b is used for transmitting the USB signal D−.

A power supply unit 190 generates a power supply voltage to be supplied to the cartridge type HDD 200. Upon receipt of the power supply voltage generated by the power supply unit 190, a power supply unit 290 supplies the power supply voltage to each block of the cartridge type HDD 200. The power supply unit 290 derives a voltage of 3.3V from a power supply voltage of 12V or 5V, and applies the derived voltage to the pin 210c. The pin 110c is grounded through a pull-down resistor R1. The pin 110c has a voltage level (hereinafter detection signal 1) of 0V before the HDD side connector 230 is electrically connected to the main body side connector 130. The detection signal 1 becomes 3.3V when the HDD side connector 230 is connected to the main body side connector 130 and the power supply pins 110c and 210c are brought into contact with each other. The detection signal 1 is inputted to the CPU 150.

On the other hand, the pin 110g is grounded through a pull-down resistor R2. The pin 110g has a voltage level (hereinafter detection signal 2) of 0V before the HDD side connector 230 is electrically connected to the main body side connector 130. The detection signal 2 becomes 5V when the HDD side connector 230 is connected to the main body side connector 130 and the power supply pins 110g and 210g are brought into contact with each other. The detection signal 2 is inputted to the CPU 150.

### (3) Operation of CPU

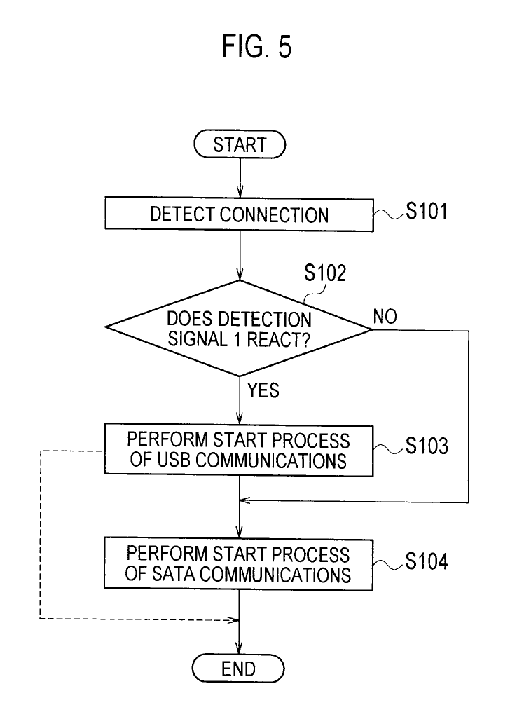

Next, the operation of the CPU 150 is described. FIG. 5 is a flowchart showing the operation of the CPU 150. In FIG. 5, only the operation related to the present invention is shown.

In step S101, the CPU 150 detects the detection signal 2 becoming 5V, i.e., the HDD side connector 230 being connected to the main body side connector 130.

In step S102, the CPU 150 checks whether the detection signal 1 is 3.3V, i.e., whether the cartridge type HDD 200 has the USB device 260 built in.

If the cartridge type HDD 200 has the USB device 260 built in, the CPU 150 directs the USB controller 180 to start USB communications in step S103. The USB controller 180 performs a start process of USB communications.

In the start process of USB communications, the USB controller 180 transmits a certain USB command to the cartridge type HDD 200. If receiving no response to the USB command from the cartridge type HDD 200, the USB controller 180 can determine that the USB device of the cartridge type HDD 200 is not operating normally. On the other hand, if receiving a response to the USB command from the cartridge type HDD 200, the USB controller 180 can determine that the USB device of the cartridge type HDD 200 is operating normally. Note that, such a check may be made with a signal at the physical layer level (for example, a signal corresponding to Ethernet (registered trademark) Link Pulse) instead of the USB command described above.

In step S104, the CPU 150 directs the SATA controller 140 to start SATA communications. The SATA controller 140 performs a start process of SATA communications.

In the start process of SATA communications, the SATA controller 140 transmits a certain SATA command to the cartridge type HDD 200. If receiving no response to the SATA command from the cartridge type HDD 200, the SATA controller 140 can determine that the SATA device of the cartridge type HDD 200 is not operating normally. On the other hand, if receiving a response to the SATA command from the cartridge type HDD 200, the SATA controller 140 can determine that the SATA device of the cartridge type HDD 200 is operating normally. Note that, such a check may be made with a signal at the physical layer level instead of the SATA command described above.

### (4) Operation Specific Example

Next, description is given of specific examples of the operations of the storage device main body 100 and the cartridge type HDD 200 according to the present embodiment.

Here, Operation Specific Example 1 and Operation Specific Example 2 are described in order to illustrate how the compatibility with the SATA standard is maintained.

Operation Specific Example 1 illustrates the operation observed when a cartridge type HDD not having a USB device built in is mounted in the storage device main body 100 according to the present embodiment.

Operation Specific Example 2 illustrates the operation observed when the cartridge type HDD 200 according to the present embodiment is mounted in a storage device main body not supporting USB communications using a SATA connector.

(4.1) Operation Specific Example 1

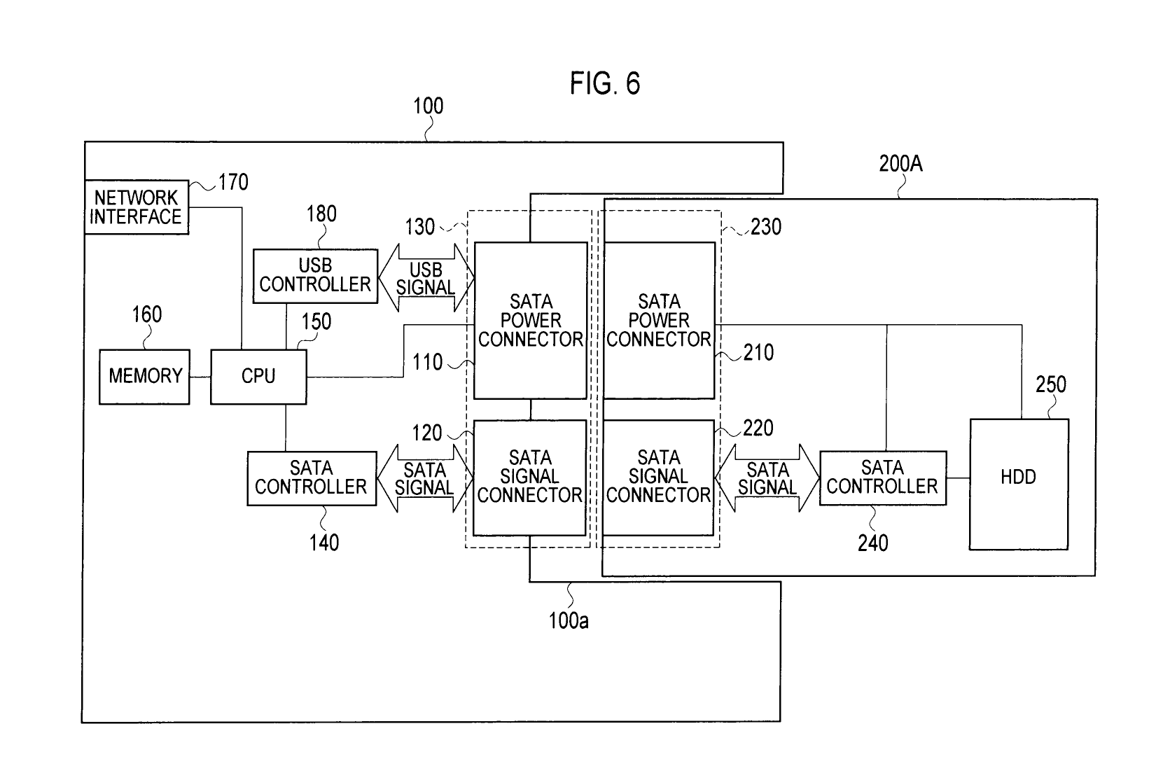

FIG. 6 is a diagram illustrating Operation Specific Example 1. FIG. 6 shows a state where a cartridge type HDD 200A not having a USB device built in is mounted in the storage device main body 100 according to the present embodiment. As shown in FIG. 6, the cartridge type HDD 200A does not include the USB device 260 and the USB controller 280 described above.

First, the CPU 150 senses that the detection signal 2 becomes 5V, i.e., that the cartridge type HDD 200A is connected to the main body side connector 130.

Next, the CPU 150 checks whether the detection signal 1 is 3.3V, i.e., whether the cartridge type HDD 200A has a USE device built in.

In Operation Specific Example 1, the cartridge type HDD 200A does not have a USB device built in, and therefore the detection signal 1 does not react (i.e., does not become 3.3V). Thus, the CPU 150 determines that the cartridge type HDD 200A is an ordinary cartridge type HDD not having a USB device built in.

Next, the CPU 150 omits the start process of USB communications, and directs the SATA controller 140 to start SATA communications. The SATA controller 140 performs the start process of SATA communications.

In this way, SATA communications can be performed as usual even when the cartridge type HDD 200A not having a USB device built in is mounted in the storage device main body 100 according to the present embodiment. The compatibility with the SATA standard can thereby be maintained.

(4.2) Operation Specific Example 2

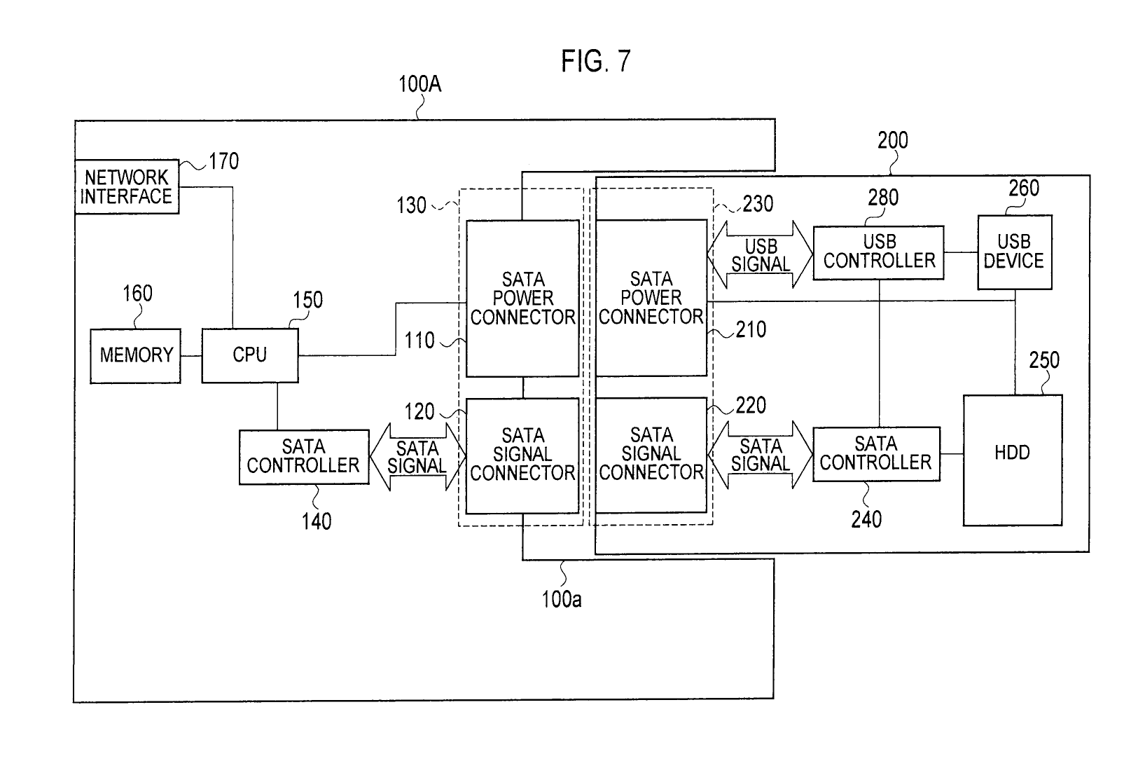

FIG. 7 is a diagram illustrating Operation Specific Example 2. FIG. 7 shows a state where the cartridge type HDD 200 according to the present embodiment is mounted in a storage device main body 100A not supporting USB communications using a SATA connector. As shown in FIG. 7, the storage device main body 100A does not include the USB controller 180 described above.

The CPU 150 senses that the cartridge type HDD 200 is connected to the main body side connector 130, and directs the SATA controller 140 to start SATA communications. The SATA controller 140 performs the start process of SATA communications.

Here, even when a power supply voltage of 3.3V is applied from the 3.3V pins of the storage device main body 100A to the 3.3V pins of the cartridge type HDD 200, the power supply voltage is lower than the withstand voltage of the USB device. Thus, although USB communications are not available, the USB device never fails.

In this way, the compatibility with the SATA standard can be maintained even when the cartridge type HDD 200 according to the present embodiment is mounted in the storage device main body 100A not supporting USB communications using a SATA connector.

### (5) Effects and Advantages of Embodiment

As described above, in the present embodiment, the SATA controller 140 of the storage device main body 100 communicates with the cartridge type HDD 200 in compliance with the SATA standards, by using the main body side SATA signal connector 120. The SATA controller 240 of the cartridge type HDD 200 communicates with the storage device main body 100 in compliance with the SATA standards, by using the HDD side SATA signal connector 220.

The USB controller 180 of the storage device main body 100 communicates with the cartridge type HDD 200 in compliance with the SATA standards, by using the pins 110a to 110c of the main body side SATA power connector 110. The USB controller 280 of the cartridge type HDD 200 communicates with the storage device main body 100 in compliance with the SATA standards, by using the pins 210a to 210c of the HDD side SATA power connector 210.

In this way, both communications compliant with the SATA standard and the USB standard can be performed by using the main body side connector 130 having a structure compliant with the SATA standard and the HDD side connector 230 having a structure compliant with the SATA standard. This allows supporting both the interface standards, i.e. the SATA standard and the USB standard, while suppressing cost increase.

Moreover, in the SATA standard, the pins 210a to 210c are power supply pins to receive a power supply voltage of 3.3V which is lower than the withstand voltage according to the USB standard. Accordingly, there is substantially no problem even if a power supply voltage of 3.3V is applied to the pins 210a to 210c. To put it another way, the USB device 260 and the USB controller 280 never fail even if the cartridge type HDD 200 is connected to the SATA connector which supplies a voltage of 3.3V.

In the present embodiment, the power supply unit 190 of the storage device main body 100 supplies a power supply voltage to the cartridge type HDD 200 by using the power supply pins other than the 3.3V pins 110a to 110c. The cartridge type HDD 200 can thereby be driven normally.

In the present embodiment, the USB controller 180 of the storage device main body 100 communicates with the cartridge type HDD 200 in compliance with the USB standard if the CPU 150 confirms that the cartridge type HDD 200 has the USB device 260 built in. Communications compliant with the USB standard can thereby be performed appropriately.

### (6) Modification of Embodiment

Although no specific description has been given of notification to the user in the above embodiment, the notification to the user may be made by adding the following configuration.

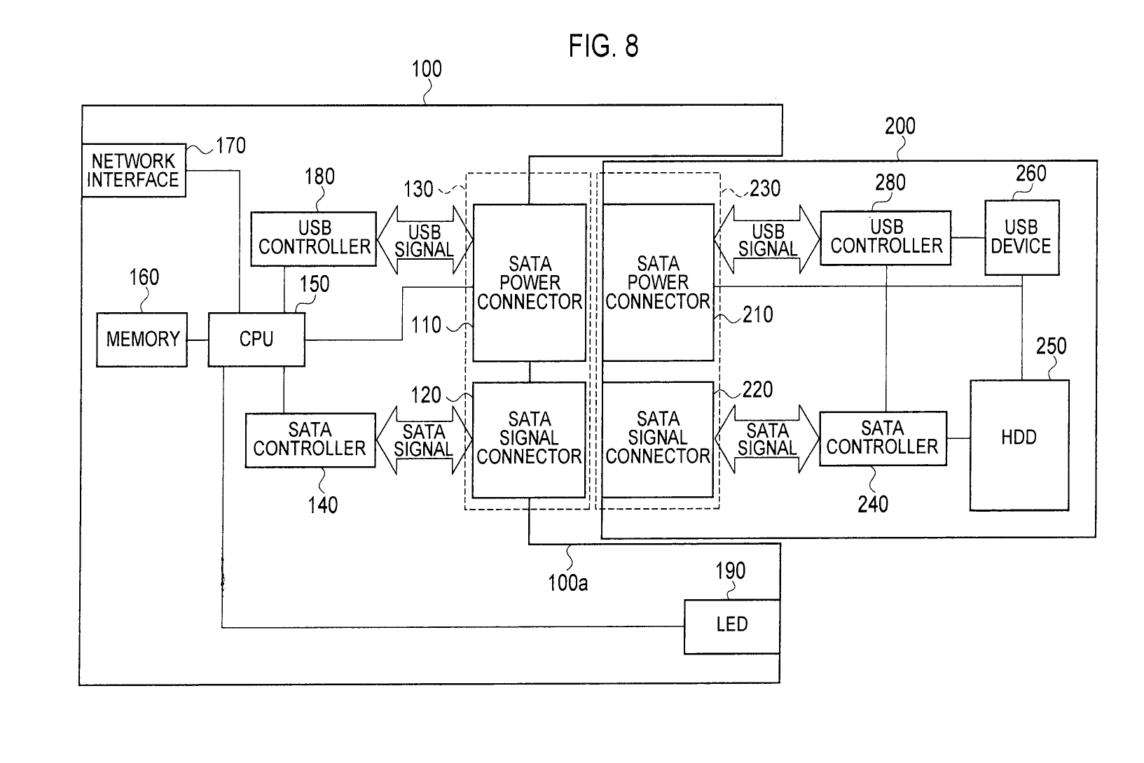

FIG. 8 is a block diagram showing a modification of the NAS according to the above embodiment.

As shown in FIG. 8, the storage device main body 100 according to this modification includes a LED 190 serving as an example of a notification unit.

The LED 190 emits light in response to a signal from the CPU 150. The CPU 150, when sensing that the HDD side connector 230 has been connected to the main body side connector 130, transmits a signal to the LED 190 to cause the LED 190 to emit light. Alternatively, if the LED 190, after detecting the connection of the HDD side connector 230 to the main body side connector 130, determines that the cartridge type HDD 200 is not operating normally, the CPU 150 transmits a signal to the LED 190 to cause the LED 190 to emit light. Note that, the NAS may have a configuration in which an LED for connector connection notification and another LED for abnormal state notification are separately provided.

Moreover, the CPU 150, when detecting the connection of the HDD side connector 230 to the main body side connector 130, transmits the information (such as web information or mail) indicating the connection from the network interface 170 to the client terminal 400 (see FIG. 1). Alternatively, if the CPU 150, after detecting the connection of the HDD side connector 230 to the main body side connector 130, determines that the cartridge type HDD 200 is not operating normally, the CPU 150 transmits the information (such as web information or mail) indicating the determination result from the network interface 170 to the client terminal 400. The client terminal 400, on the basis of the information (such as web information or mail), displays a message on the screen (for example, Web screen), the message showing that the HDD side connector 230 has not been connected to the main body side connector 130, the HDD side connector 230 has been connected to the main body side connector 130, or the cartridge type HDD 200 is not operating normally.

### (7) Other Embodiments

Although the invention has been described by way of embodiment in the foregoing, it should be understood that those embodiments are not intended to limit the invention. Various alternatives, implementation examples, and application techniques will be apparent to those skilled in the art without departing from the scope and spirit of this invention.

In the above embodiment, a case has been given where the first interface standard is the SATA standard and the second interface standard is the USB standard.

Alternatively, the first interface standard may be another interface standard similar to the SATA standard. For example, the Serial Attached SCSI (SAS) standard, which is one of interface standards, may be the first interface standard.

Moreover, the second interface standard may be another interface standard similar to the USE standard. For example, the Low Voltage Differential Signaling (LVDS) standard, which is one of interface standards, may be the second interface standard.

The above mentioned embodiment has been described in the case where the communication system of the present invention is applied to the NAS. However, the communication system of the present invention may be applied to an IP-STB (Set Top Box) or a broadband router. In the case where the communication system of the present invention is applied to an IP-STB, the STB main body corresponds to the main body device, and the storage medium inserted in the STB main body corresponds to the external device. Also, in the case where the communication system of the present invention is applied to a broadband router, the main body router corresponds to the main body device, and the storage medium inserted in the main body router corresponds to the external device. Further, any electronic devices may be employed as the main body device and the external device as long as they can perform communications using the USB standard.

In this manner, the present invention naturally includes various embodiments not specifically described herein. Accordingly, the technical scope of the present invention should be defined only by the attached claims constructed based on the above description.

What is claimed is:

1. A main body device comprising:
a main body side connector to which an external device is connected and having a structure compliant with a first interface standard;
a first main body side communication unit for communicating with the external device in compliance with the first interface standard by using a main body side signal pin provided in the main body side connector; and
a second main body side communication unit for communicating with the external device in compliance with a second interface standard by using a selected number of main body side power supply pins provided in the main body side connector.

2. The main body device according to claim 1, wherein,
in the first interface standard, the selected number of main body side power supply pins are used for supplying a power supply voltage lower than a withstand voltage according to the second interface standard.

3. The main body device according to claim 1, further comprising:
a check unit for checking whether the external device includes any specific built-in device to perform communications compliant with the second interface standard, according to a voltage applied from the external device to any one of the selected number of main body side power supply pins,
wherein the second main body side communication unit communicates with the external device in compliance with the second interface standard if the check unit confirms that the external device includes the specific built-in device.

4. The main body device according to claim 1, further comprising:
a main body side power supply unit for supplying a power supply voltage to the external device by using the rest of the main body side power supply pins other than the selected number of the main body side power supply pins.

5. The main body device according to claim 1, wherein
the first interface standard is a SATA (Serial Advanced Technology Attachment) standard or a SAS (Serial Attached SCSI) standard.

6. The main body device according to claim 1, wherein
the second interface standard is a USB (Universal Serial Bus) standard or a LVDS standard.

7. An external device comprising:
an external side connector connected to a main body device and having a structure compliant with a first interface standard;
a first external side communication unit for communicating with the main body device in compliance with the first interface standard by using an external side signal pin provided in the external side connector; and
a second external side communication unit for communicating with the main body device in compliance with a second interface standard by using a selected number of external side power supply pins provided in the external side connector.

8. The external device according to claim 7, wherein,
in the first interface standard, the selected number of external side power supply pins are used for receiving a power supply voltage lower than a withstand voltage according to the second interface standard.

9. The external device according to claim 7, further comprising:
a specific device to perform communications compliant with the second interface standard.

10. The external device according to claim 7, further comprising:
an external side power supply unit for receiving a power supply voltage from the main body device by using the rest of the external side power supply pins other than the selected number of the external side power supply pins.

11. The external device according to claim 7, wherein
the first interface standard is a SATA (Serial Advanced Technology Attachment) standard or a SAS (Serial Attached SCSI) standard.

12. The external device according to claim 7, wherein
the second interface standard is a USB standard or a LVDS (Low Voltage Differential Signaling) standard.

13. A communication system comprising:
a main body device; and
an external device mounted in the main body device,
wherein the main body device comprises:
a main body side connector to which an external device is connected and having a structure compliant with a first interface standard;
a first main body side communication unit for communicating with the external device in compliance with the first interface standard by using a main body side signal pin provided in the main body side connector; and
a second main body side communication unit for communicating with the external device in compliance with a second interface standard by using a selected number of main body side power supply pins provided in the main body side connector, and
the external device comprises:
an external side connector connected to the main body device and having a structure compliant with the first interface standard;
a first external side communication unit for communicating with the main body device in compliance with the first interface standard by using an external side signal pin provided in the external side connector; and
a second external side communication unit for communicating with the main body device in compliance with the second interface standard by using a selected number of external side power supply pins provided in the external side connector.
